(19) United States
(12) Patent Application Publication
(10) Pub. No.: US 2026/0269958 A1
(43) Pub. Date: Sep. 10, 2026

(54) Systems and Methods for Monitoring Signal Quality for Data Interface Devices

(71) Applicant: PARADE TECHNOLOGIES, LTD., San Jose, CA (US)

(72) Inventors: Canruo Ying, Santa Clara, CA (US); Pin-Hsuan Liao, Hsinchu (TW)

(21) Appl. No.: 19/197,911

(22) Filed: May 2, 2025

Related U.S. Application Data
(60) Provisional application No. 63/766,916, filed on Mar. 4, 2025.

(51) Int. Cl. H04B 17/20; H04L 25/03

(52) U.S. Cl. CPC H04B 17/201; H04L 25/03057

(57) ABSTRACT

This application is directed to a wireline receiving device that performs in-situ non-destructive eye diagram measurement for an analog slicer based on data transmitted to the device. The device obtains output data from one or more analog slicers. The output data represents a result of sweeping across a plurality of indices of a digital wireline signal. The device produces a cumulative density function (CDF) of the digital wireline signal based on an accumulated output data from the one or more analog slicers. The device causes the CDF of the digital wireline signal to be differentiated to produce a probability density function (PDF) of the digital wireline signal for each respective index of the plurality of indices. And, based on the PDF of the digital wireline signal, the device determines a signal strength of the digital wireline receiver.

### RELATED APPLICATIONS

This application claims priority to and is a non-provisional of U.S. Provisional Application Ser. No. 63/766,916, entitled “Dynamic In-Situ Adaptation of Data Interface,” filed on Mar. 4, 2025, which is incorporated by reference herein in its entirety.

### TECHNICAL FIELD

The disclosed implementations relate generally to data transmission technology including, but not limited to, methods, systems, and devices for measuring signal integrity of wireline communications via eye-diagram measurement.

### BACKGROUND

Many electronic devices are physically coupled to each other and communicate with each other using data links and interfaces that comply with high-speed serial computer expansion bus standards (e.g., Peripheral Component Interconnect (PCI) Express). An example of such an electronic device is a digital wireline receiver.

An eye diagram provides a graphical representation of a digital signal's quality and can be an effective method for measuring signal integrity in digital wireline communications. The eye diagram is constructed by folding a continuous signal in a time domain with unit interval spacing. The resulting graph represents the probability density function of the folded signal (e.g., a modulo of the unit interval). Each vertical slice (e.g., in time, on a timescale) of the eye diagram represents the probability of the signal having a particular voltage at a particular phase of the unit interval.

It would be beneficial to make eye diagram measurement more robust in this field to better utilize data that is typically already being collected, or capable of being collected, to improve monitoring of communication quality for wireline receivers.

### SUMMARY

This application is directed to methods, electronic systems, electronic devices, electronic circuits, data links, data ports, and data interfaces that monitors signal quality based on dynamic eye diagram measurement (e.g., in wireline receivers). High speed communication integrated circuits (ICs) in today's world are becoming increasingly more complex due to high data rates required by applications such as high-resolution displays and high-speed data transfer. One way of determining the fidelity of a wireline signal is by constructing and analyzing an eye diagram that represents the probability of the signal having a particular voltage at a particular phase of the unit interval.

The inventors of the instant application recognized an important drawback of current techniques for eye diagram measurement, which is that only the inner eye opening is measured, and no other information is extracted. To address these shortcomings, the inventors have developed various novel implementations for analyzing aspects of the eye diagram data that were not previously utilized in order to get a more comprehensive understanding of the quality of signals transmitted by electronic devices such as digital wireline receivers. Specifically, the inventors have determined that differentiating the output of an accumulator (e.g., a cumulative density function (CDF)) to produce a probability density function (PDF) of a signal obtained from an error slicer allows for analysis of the entire eye without any modification to analog circuitry employed by the system. The implementations outlined in this disclosure is a method to allow non-destructive eye monitoring that allows the entire eye to be measured without additional analog circuitry.

In one aspect, a method is implemented at an electronic device (e.g., a data interface device) for adapting a data communication channel. The electronic device is configured to perform in-situ non-destructive eye diagram measurement for an analog data slicer based on data transmitted to a digital wireline receiver. The device obtains output data from one or more analog slicers. The output data represents a result of sweeping across a plurality of indices of a digital wireline signal. The device produces a cumulative density function (CDF) of the digital wireline signal based on an accumulated output data from the one or more analog slicers. The device causes the CDF of the digital wireline signal to be differentiated to produce a probability density function (PDF) of the digital wireline signal for each respective index of the plurality of indices. And, based on the PDF of the digital wireline signal, the device determines a signal strength of the digital wireline receiver. In some embodiments, this method may be applied for in-situ non-destructive eye diagram measurement for analog slicers of digital wireline receivers.

In another aspect, a non-transitory computer-readable storage medium stores one or more programs to be executed by one or more processors. The one or more programs include instructions for implementing any of the above methods for adapting an electronic device in a data interface or a data communication channel.

In yet another aspect, an electronic device includes a sequence of modulation circuits, each of which having one or more adjustable configurations, an adaptive equalizer controller coupled to the sequence of modulation circuits, and memory storing one or more programs configured for execution by the adaptive equalizer controller and the sequence of modulation circuits. The one or more programs include instructions for implementing any of the above methods for adapting a data interface or a data communication channel.

In yet another aspect, an electronic device includes a sequence of modulation circuits and an adaptive equalizer controller. The sequence of modulation circuits is configured to obtain an input data signal and process the input data signal to generate an output data signal including a first data sample. Each modulation circuit has one or more adjustable configurations. The adaptive equalizer controller is coupled to the sequence of modulation circuits, and configured for determining a first residual error of the first data sample, adjusting a first adjustable configuration of a first modulation circuit based on the first residual error, and adjusting a second adjustable configuration of a second modulation circuit based on the first adjustable configuration.

These illustrative implementations are mentioned not to limit or define the disclosure, but to provide examples to aid understanding thereof. Additional implementations are discussed in the Detailed Description, and further description is provided there.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram of an example electronic system in which electronic devices are electrically connected via a data link, in accordance with some implementations.

FIG. 2 is an example PCI Express electronic system in which a first electronic device or component is electrically coupled to a second electronic device or component via a data link, in accordance with some implementations.

FIG. 3 shows a visual depiction of an eye diagram, in accordance with some implementations.

FIGS. 4A through 4C show various architectures for high-speed data transmission links, including architectures that include eye monitoring software and/or hardware, in accordance with some implementations.

FIG. 5 shows a first example method for measuring an eye diagram, in accordance with some implementations.

FIG. 6 shows a modified architecture of the proposed eye monitoring method, in accordance with some implementations.

FIGS. 7A and 7B shows outputs from the eye monitor configurations, in accordance with some implementations.

FIGS. 8A and 8B show additional example outputs from eye monitoring software after performing statistical distribution calculations, in accordance with some implementations.

FIGS. 9A and 9B show example aspects of an eye-sweeping process using the claimed techniques.

FIG. 10 is a flow diagram of an example method 1000 for in-situ eye diagram measurement, in accordance with some implementations.

Like reference numerals refer to corresponding parts throughout the several views of the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

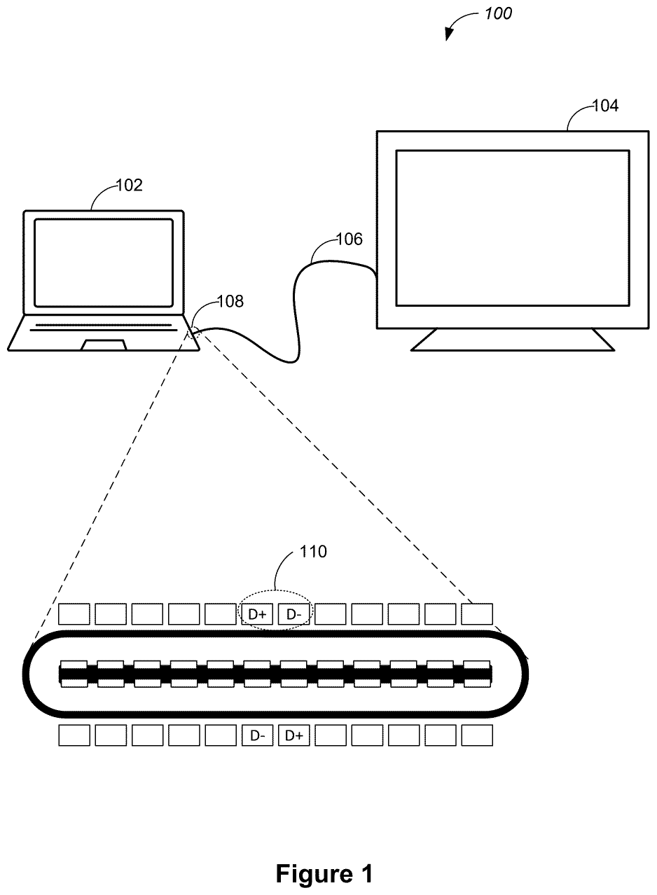

FIG. 1 is a block diagram of an example electronic system 100 in which a first electronic device 102 is electrically coupled to a second electronic device 104 via a data link 106, in accordance with some implementations. The first electronic device 102 and second electronic device 104 are configured to exchange data via the data link 106. In an example, the first electronic device 102 includes a video source, and the second electronic device 104 includes a display device. The display device has a screen configured to display visual content provided by the first electronic device 102 via the data link 106. In another example not shown, the first electronic device 102 includes a desktop computer, and the second electronic device 104 includes a mobile phone that exchanges data with the desktop computer via the data link 106. Examples of the electronic devices 102 and 104 include, but are not limited to, a desktop computer, a laptop computer, a tablet computer, a video player, a camera device, a gameplayer device, or other formats of electronic devices which are configured to provide data or receive data. Video data, audio data, text, program data, control data, configuration data, or any other data are transmitted between the first and second electronic devices 102 and 104 via the data link 106.

The data link 106 includes two connectors 108 at two of its ends. The two connectors 108 are configured to connect the data link 106 to respective connectors 108 of the first electronic device 102 and second electronic device 104. For example, the connector 108 is a DisplayPort connector having a digital display interface developed by a consortium of personal computer and chip manufacturers and standardized by the Video Electronics Standards Association (VESA). The DisplayPort connector is configured to connect the data link 106 to the first electronic device 102 and carry video, audio, and control data according to a data communication protocol. In another example, the connector 108 is a universal serial bus (USB) connector (e.g., configured to connect a computer to a peripheral device). Exemplary types of the USB connector include, but are not limited to, USB-A, USB-B, USB-C, USB Micro-A, USB Micro-B, USB Mini-B, USB 3.0 A, USB 3.0 B, USB 3.0 Micro B, and USB Micro-AB. Further, a data communication protocol of USB4 is applied to communicate data using a USB-C connector, thereby providing a throughput of up to 40 Gbps, power delivery of up to 100 W, support for 4K and 5 K displays, and backward compatibility with USB 3.2 and USB 2.

In some implementations, the connector 108 includes a bidirectional channel for communicating a stream of data between the first and second electronic device 102 and 104. The bidirectional channel of the connector 108 includes two data lanes and a pair of differential pins 110 coupled to the two data lanes. The pair of differential pins 110 are configured to receive a differential input signal from the first electronic device 102 or the second electronic device 104, and the differential input signal carries a serial data command or serial content data (e.g., video or audio data) that are communicated via the two data lanes of the connector 108. As such, the two data lanes, and pair of differential pins 110 of the connector 108 are configured to facilitate bidirectional communication between the first electronic device 102 and the second electronic device 104. The bidirectional channel is a data channel or an auxiliary channel. Specifically, the auxiliary channel of the connector 108 is used for communication of additional serial data beyond video and audio data, such as consumer electronics control (CEC) commands. In some implementations, the pair of differential pins 110 is coupled to a dedicated set of twisted-pair wires configured to carry two input signals of the differential input signal.

Each connector 108 of the data link 106 is configured to be coupled to a respective connector 108 of the first electronic device 102 and a respective connector 108 of the second electronic device 104. Each connector 108 of the data link 106 is bidirectional, so is each respective connector 108 of the electronic devices 102 and 104. When the connector 108 of the data link 106 is coupled to the first or second electronic device 102 or 104, the pair of differential pins 110 of the connector 108 of the data link 106 are physically and electrically coupled to a pair of differential pins 110 of the connector 108 of the first or second electronic device 102 or 104. The pair of differential pins 110 of the connector 108 of the first or second electronic device 102 or 104 is configured to receive data from, or transmit data to, the differential pins 110 of the connector 108 of the data link 106.

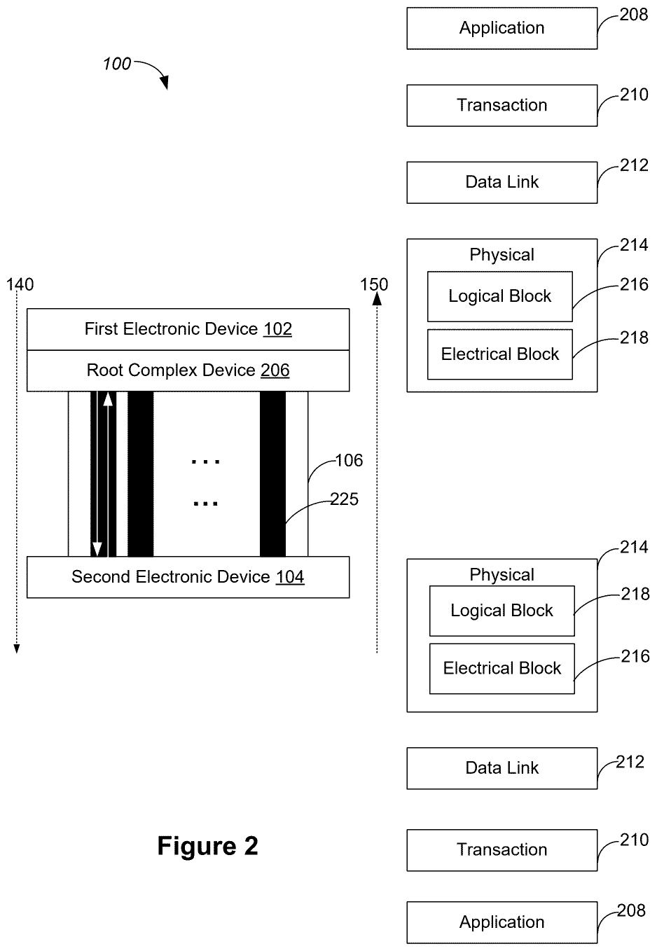

FIG. 2 is an example PCI Express electronic system 100 in which a first electronic device 102 or component is electrically coupled to a second electronic device 104 or component via a data link 106, in accordance with some implementations. In an example, the first electronic device 102 includes a central processing unit (CPU) of a personal computer, and the second electronic device 104 is a peripheral component of the personal computer, such as a graphics card, a hard drive, a solid-state drive, a Wi-Fi communication module, or an Ethernet card. The data link 106 includes a connection port for receiving from the second electronic device 104. The connection port is optionally formed on a mother board of the personal computer. The data link 106 complies with PCI Express (also described herein as PCIe), which is a high-speed serial computer expansion bus standard, and provides an interface to communicate data packets between the first and second electronic devices 102 and 104 in compliance with the PCI Express. The data link 106 is a serial data bus including one or more data transmission channels 225. Each channel 225 includes two wire sets for transmitting and receiving data packets, thereby supporting full-duplex communication between the first and second electronic devices 102 and 104. In some examples, the data link 106 has 1, 4, 8, or 16 channels 225 coupled in a single data port of the data link 106. For each lane, the two wire sets correspond to a downstream data direction 140 or an upstream data direction 150 defined with respect to the first electronic device 102. Optionally, each wire set includes two wires for carrying a pair of differential signals.

In some implementations, the first electronic device 102 includes or is coupled to a root complex device 206 that is further coupled to the data link 106. The root complex device 206 is configured to generate requests for transactions including a series of one or more packet transmissions on behalf of the first electronic device 102. Examples of the transactions include, but are not limited to, Memory Read, Memory Read Lock, IO Read, IO Write, Configuration Read, Configuration Write, and Message. In some implementations, the first electronic device 102 is coupled to one or more additional electronic devices besides the second electronic device 104. The data link 106 includes one or more switch devices to couple the root complex device 206 of the first electronic device 102 to multiple endpoints including the second electronic device 104 and additional electronic devices not shown in FIG. 1.

PCI Express is established based on a layered model including an application layer 208, a transaction layer 210, a data link layer 212, and a physical layer 214. As the top layer, the application layer 208 is implemented in software programs, such as Ethernet, NVMe, SOP, AHCI, and SATA. In the transaction layer 210, each transaction of a series of packet transmissions is implemented as requests and responses separated by time. For example, a memory-related transaction is translated to device configuration and control data transferred to or from the second electronic device 104 (e.g., a memory device). Data packets associated with each transaction are managed by data flows on the data link layer 212. The physical layer 214 of PCI Express controls link training and electrical (analog) signaling, and includes a logical block 216 and an electrical block 218. The logic block 116 defines ordered data sets in training states (e.g., TS1 and TS2), and the electrical block 118 defines eye diagram characteristics and analog waveforms. Each layer of the layered model includes first specifications for a transmitting end where a root complex device 206 is coupled and second specifications for a receiving end where a peripheral component (e.g., the second electronic device 104) is coupled.

As high frequency signals are transmitted within the channels 225 of the data link 106, these signals are distorted and spread over sequential symbols and result in inter symbol interferences (ISI) and bit errors at the receiving end of the second electronic device 104. These ISI and bit errors can be suppressed by a feed-forward equalizer (FFE) that is coupled serially on a path of the data link 106 and configured with equalization settings using an equalization procedure. In an example, the FFE includes a finite impulse response (FIR) filter. The equalization procedure is implemented when a high-speed data transfer rate needs to be initialized, when an equalization request is issued from the application layer 208, or when a BER exceeds a data error tolerance. In some implementations, initiation and termination of the equalization procedure are detected on the physical layer 214 based on data packets transferred over the data link 106.

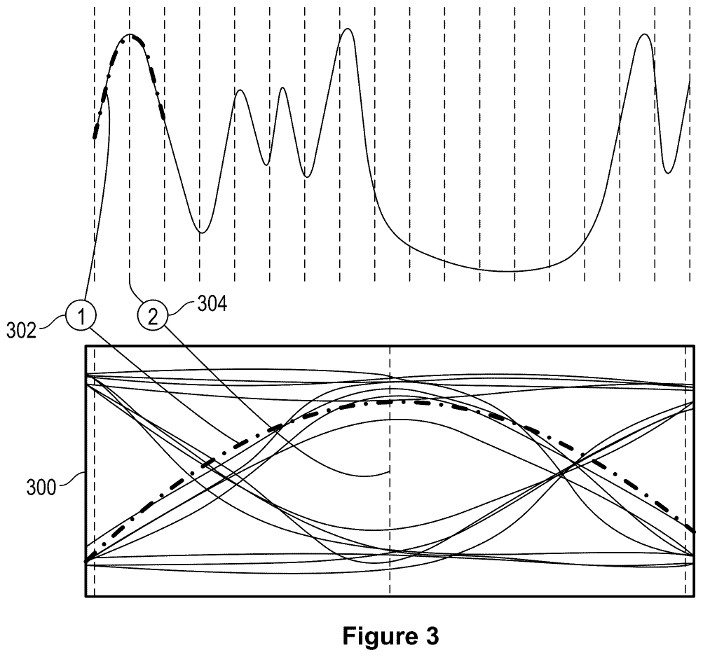

FIG. 3 shows a visual depiction 300 of an eye diagram, in accordance with some implementations. In the visual depiction 300, the signal 302 (marker 1) is being folded at double the unit interval (e.g., having a multiple of “2×”, a “2×” unit interval). In accordance with some implementations, the folding rate of double the unit interval is (e.g., the “2×” unit interval) is utilized rather than a “1×” unit interval in accordance with determining that presenting the visual depiction 300 in the “2×” unit interval results in ease of viewing. In accordance with some implementations, the dashed lines 304 (marker 2) are unit interval spaced (e.g., a “1×” unit interval). When the signal quality is good, the eye is described as “open,” meaning that the voltage levels representing each symbol (e.g., 0s and 1s) are non-overlapping and can be sampled without errors, in accordance with some implementations. Conversely, when the signal quality is poor, the eye is described as “closed,” and the symbol levels are not clearly separated, causing errors when sampled indicating that the voltage levels are overlapping at a rate that is higher than intended.

In some implementations of the digital communication links described herein, the signal inside an analog slicer-based receiver cannot be measured accurately since the analog slicer converts continuous input into binary output and a substantial amount of the voltage information is thus lost, making signal integrity assessment difficult. In some implementations, before determining whether to perform the multiple dimensions of indexing, a determination is made related to the signal integrity based on a resultant visualization obtained based on indexing along a single dimension.

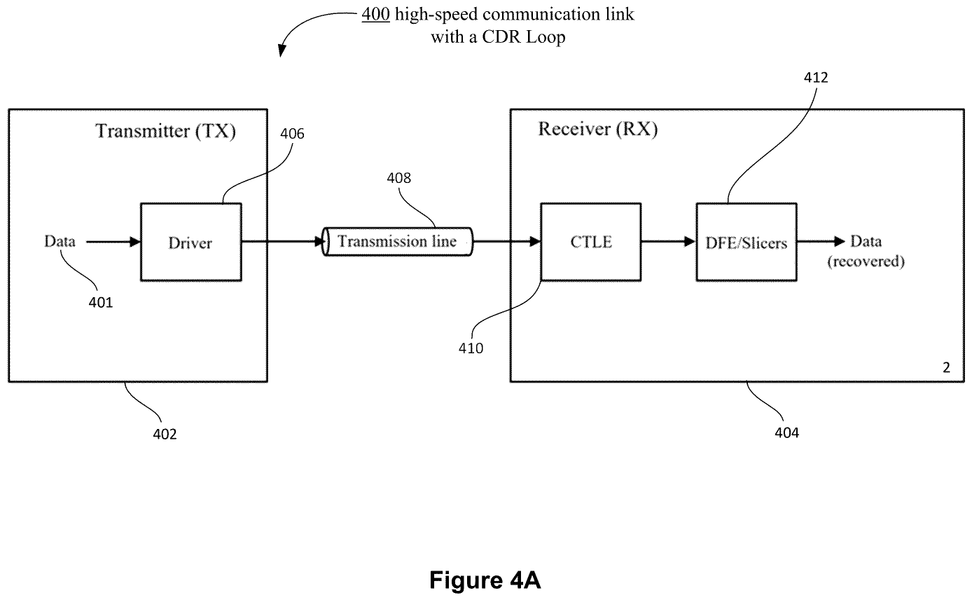

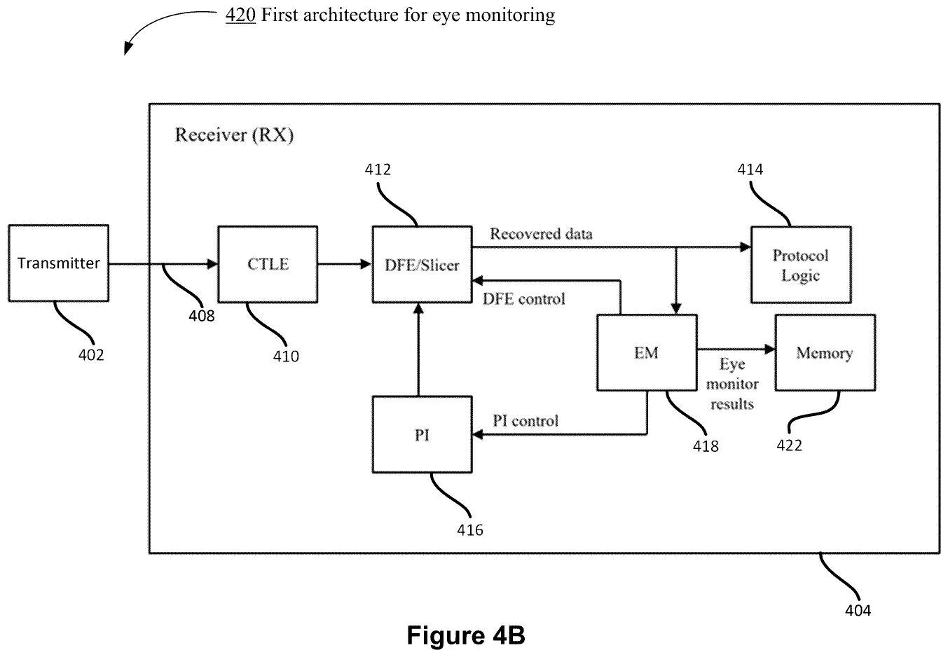

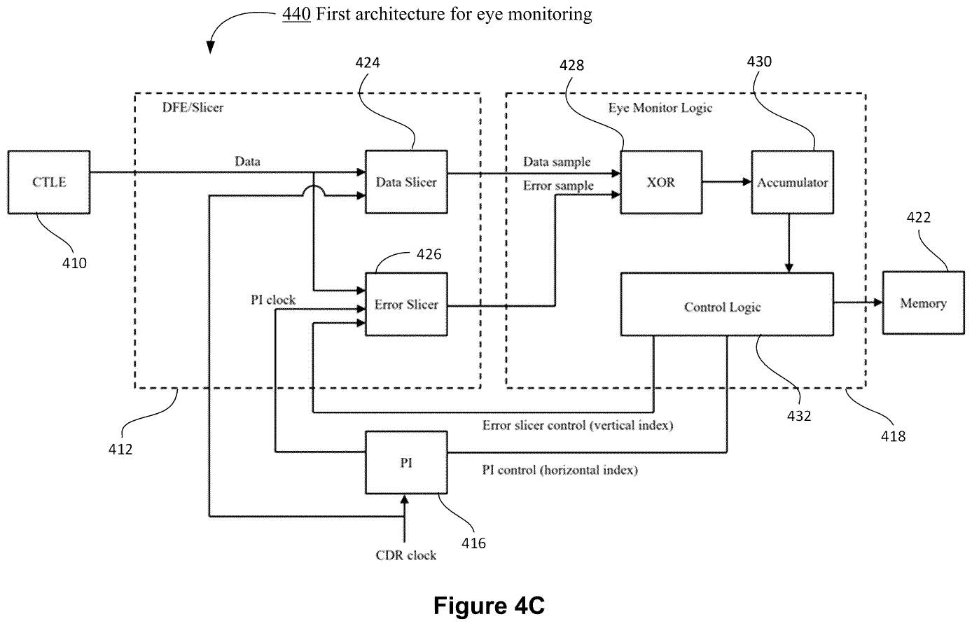

FIGS. 4A through 4C show various architectures for high-speed data transmission links, including architectures that include eye monitoring software and/or hardware, in accordance with some implementations.

FIG. 4A shows a first example of a high-speed link 400 having a clock and data recovery (CDR) loop with the relevant blocks shown, in accordance with some implementations. One of skill in the art will recognize that more, less, and/or different components may be used to achieve results of the implementations described herein. The transmitter IC 402 contains a driver 406 that sends data 401 across a transmission line 408. The receiver IC 404 contains the analog front end, which can contain various analog equalizers such as a continuous time linear equalizer (CTLE) 410 to compensate for any loss from the transmission line 408, in accordance with some implementations. A decision-feedback equalizer (DFE) 412 is a digital equalizer that contains slicers (e.g., analog comparators) that may be configured to convert voltage levels into digital symbols (such as 0s and 1s), in accordance with some implementations. In some implementations, it may be desirable to be able to measure the signal quality (e.g., the eye diagram) of the signal at the slicer input, since it is the final analog point on the receiver data path before conversion to digital domain by the slicers.

FIG. 4B shows a first architecture 420 for performing eye diagram measurement, in accordance with some implementations. The data from transmitter 402 arrives at the receiver 404. The CTLE 410 equalizes the data signal, which then arrives at the DFE 412. The DFE 412 contains the slicers that convert the analog voltage into digital symbol levels (e.g., 0s and 1s) for use by various logic (e.g., protocol logic 414) as defined by protocol or application. The digital data is also sent to the eye monitoring logic 418 that measures the eye diagram and saves the result in memory 422. In accordance with some implementations, the eye monitoring logic 418 is also configured to control the DFE/slicer 412 and the PI 416. In some implementations, the PI 416 is configured to provide a variable phase clock for one or more of the slicers of the DFE 412 (e.g., a data slicer and/or an error slicer). Eye monitoring results generated by the eye monitoring logic 418 are stored in memory 422.

FIG. 4C shows a more detailed view 440 of the first architecture 420 shown in FIG. 4B. The DFE 412 receives the equalized signal from the CTLE 410 and two sets of slicers are used to convert the signal into digital levels. The data slicer 424 samples the signal using a CDR clock at each unit interval. The error slicer 426 samples the same signal but at an adjustable phase and voltage threshold level. The output of the data slicer 424 and error slicer 426 are compared in the eye monitor logic 418 using an XOR logic 428, the output of which is processed by an accumulator 430 and sent to memory 422. The control logic 432 provides the control signal for the PI 416 and error slicer 426 to tune its horizontal and vertical sampling position.

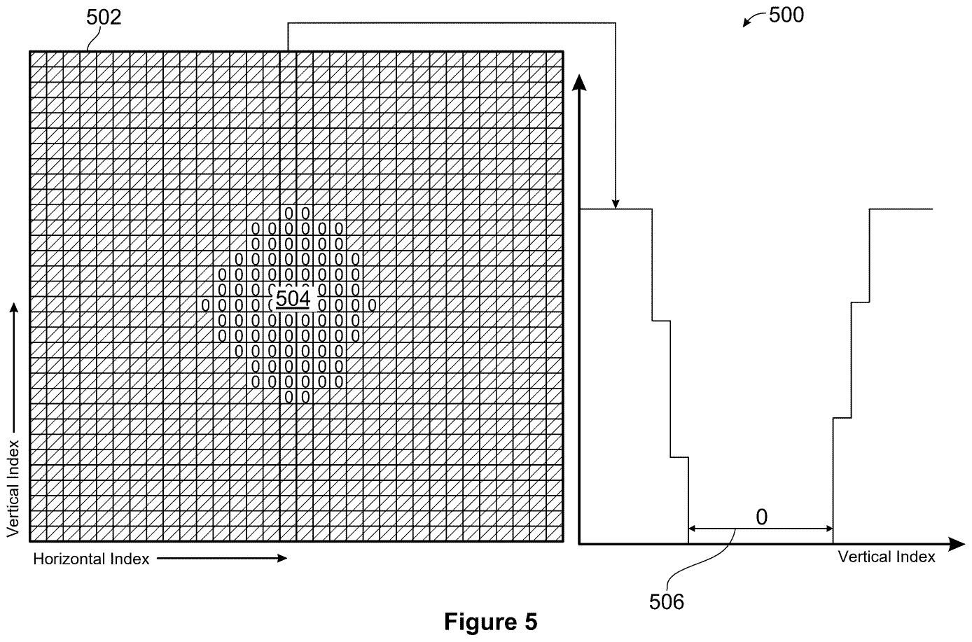

FIG. 5 shows a first example method 500 for measuring an eye diagram, in accordance with some implementations. The error slicer control is swept across each of the horizontal and vertical indices to form a two-dimensional graphical representation 502 to illustrate the results. In some implementations, this process of sweeping across each of the horizontal and vertical indices causes enables a user to vary the slicer decision threshold, in accordance with some implementations. In some implementations, for each threshold level, the eye monitoring logic counts the output of the XOR logic. If the error slicer and data slicer results differ, the accumulator output is non-zero (e.g., as illustrated by the portions of graphical representation 502 that are outside of a portion 504 representing an eye of the signal diagram), in accordance with some embodiments. In accordance with some implementations, the PI control is also swept to test each horizontal point. After every sufficient horizontal and vertical indices are searched, the region 506 where the accumulator outputs zero is the eye opening.

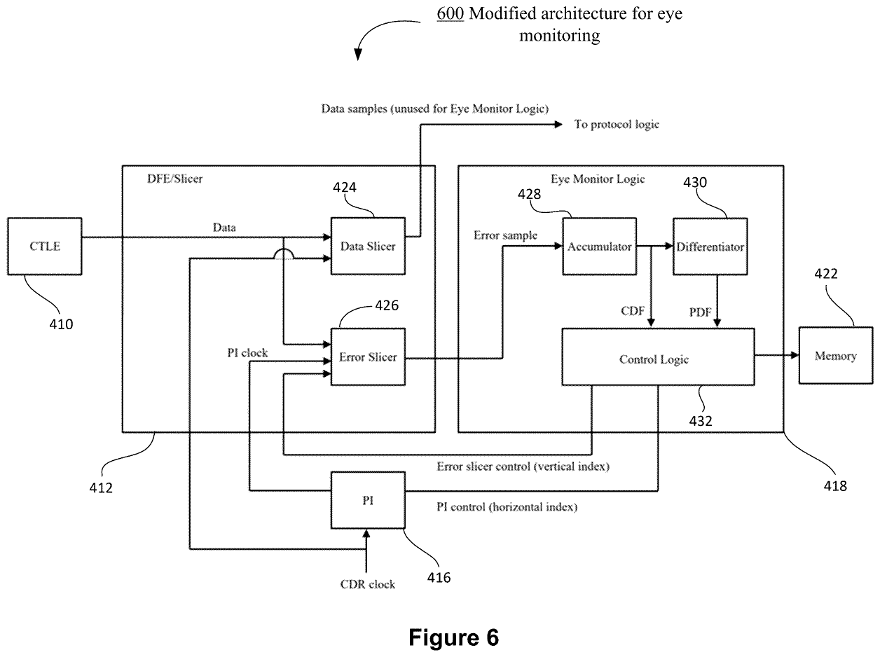

FIG. 6 shows a modified architecture of the proposed eye monitoring method 600, in accordance with some implementations. The error slicer output is processed by an accumulator 430 to produce a cumulative density function (CDF) based signal, which may be differentiated by a differentiator 430 to produce a probability density function (PDF) based signal. The PDF based signal, when constructed by sweeping both the horizontal and vertical indices, becomes the eye diagram. In accordance with some implementations, the modified architecture does not alter the analog portion of the existing method, so that it can be added as an alternative while keeping the existing method and implemented purely in digital logic. That is, one example benefit of the configuration shown in FIG. 6 is that there are no required changes to the analog configuration. And the additional analysis on the analog portion allows for fine tuning and other modifications to the digital circuitry based on the information that would not be collected by conventional eye diagram measurement techniques.

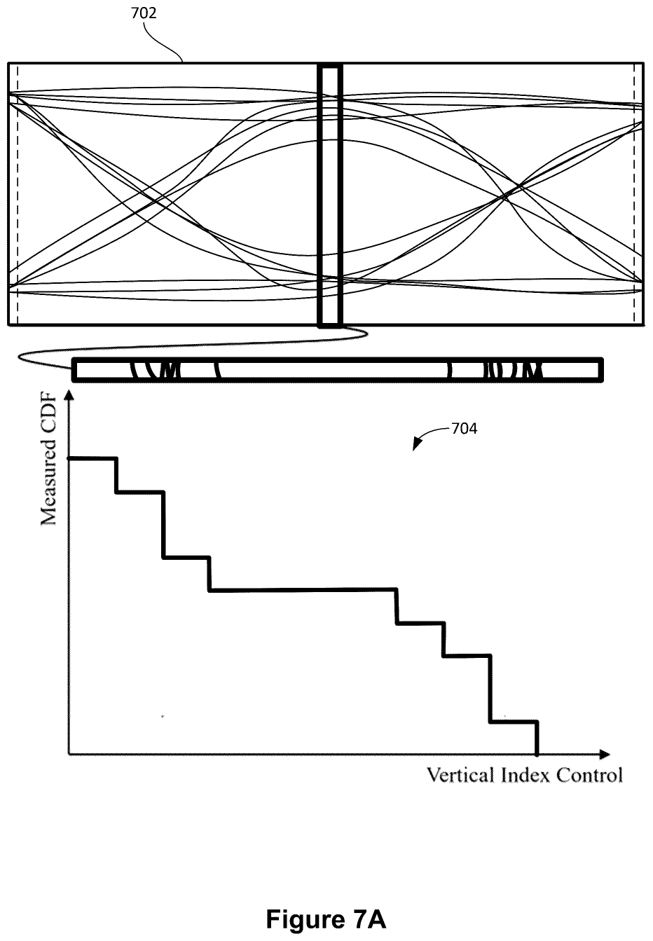

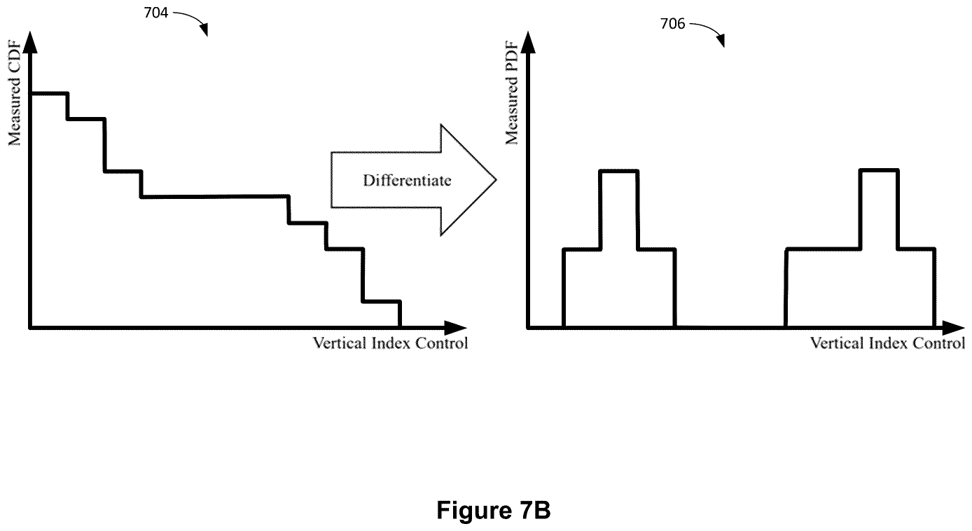

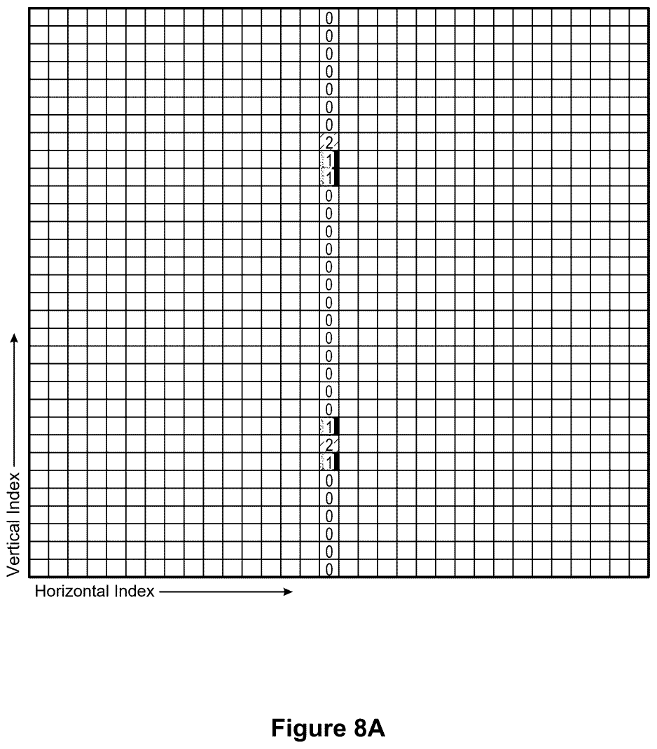

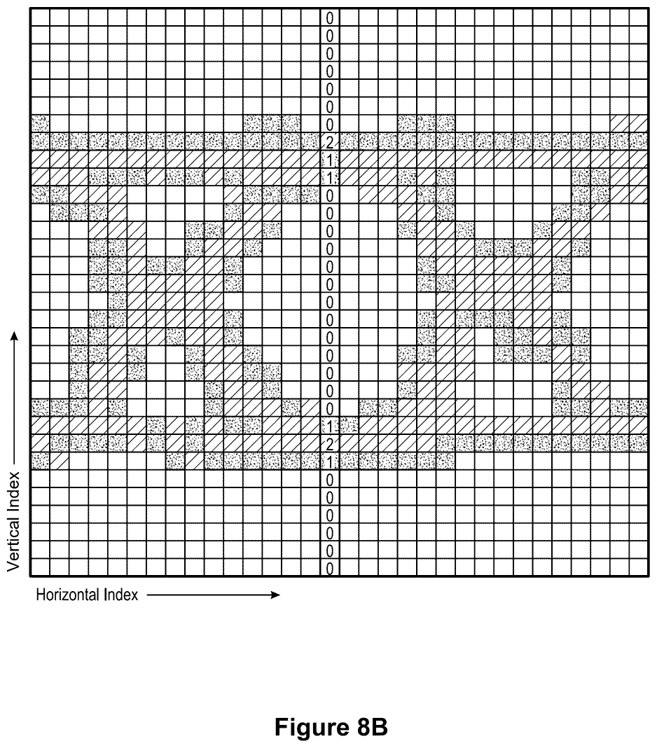

An example of constructing the eye diagram using the proposed method is shown below in FIGS. 7A, 7B, 8A, and 8B. In some implementations, the analog components required for the example shown in FIGS. 7A, 7B, 8A, and 8B as are shown in any one of the architectures shown in FIGS. 4A to 4C.

FIGS. 7A and 7B shows outputs from the eye monitor configurations, in accordance with some implementations. In FIG. 7A, the upper graph 702 illustrates a graph of voltage measurements for a communication channel folded across a time dimension.

FIG. 7A shows the accumulator output (CDF) of the eye monitor logic as the vertical index control (error slicer threshold control) is swept. In the region where signal density is zero (e.g., the eye opening), the CDF is constant.

FIG. 7B shows the differentiator output (PDF) of the eye monitor logic as the vertical index control (error slicer threshold control) is swept. The differentiator output is defined as the following:

$$PDF [ i ] = C D F [ i ] - C D F [ i + 1 ] . \qquad Equation 1$$

The PDF is then stored in memory to be human accessible. When each value of the measured PDF is read from memory, it can be assembled as FIGS. 8A and 8B.

FIGS. 8A and 8B show additional example outputs from eye monitoring software after performing statistical distribution calculations, in accordance with some implementations.

FIG. 8A shows an example representation of an eye diagram output when the horizontal index is fixed (i.e., the CDR clock phase is unaltered at the PI), by sweeping the vertical index (i.e., sweeping the error slicer threshold), the PDF of the signal at a fixed phase is measured. This is equivalent to one column of the eye diagram. The coloring is varied according to the value of the PDF.

FIG. 8B shows the same process in FIG. 8A being applied to every horizontal index (i.e., PI control index). The PI varies the sampling phase of the error slicer, and if every phase position is measured, the entire eye diagram is measured.

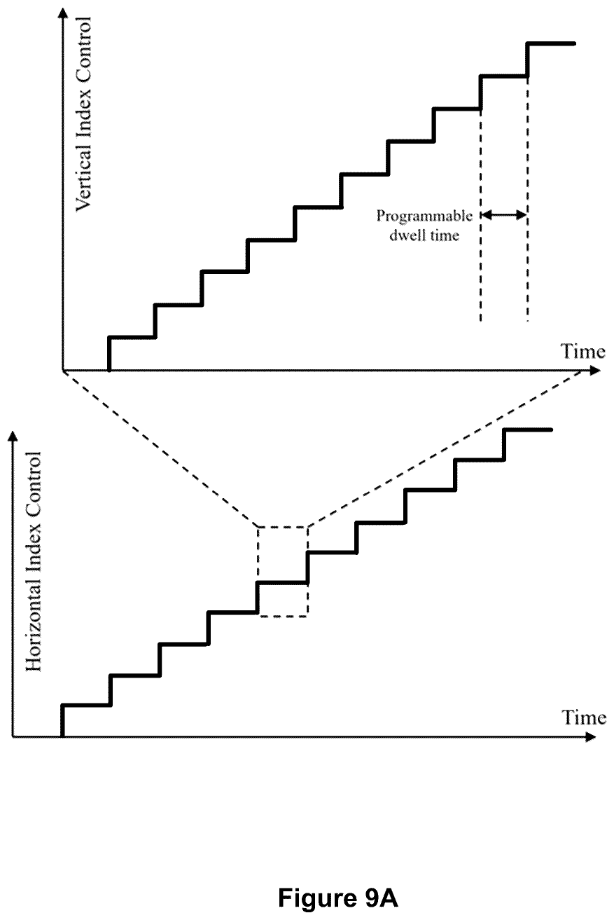

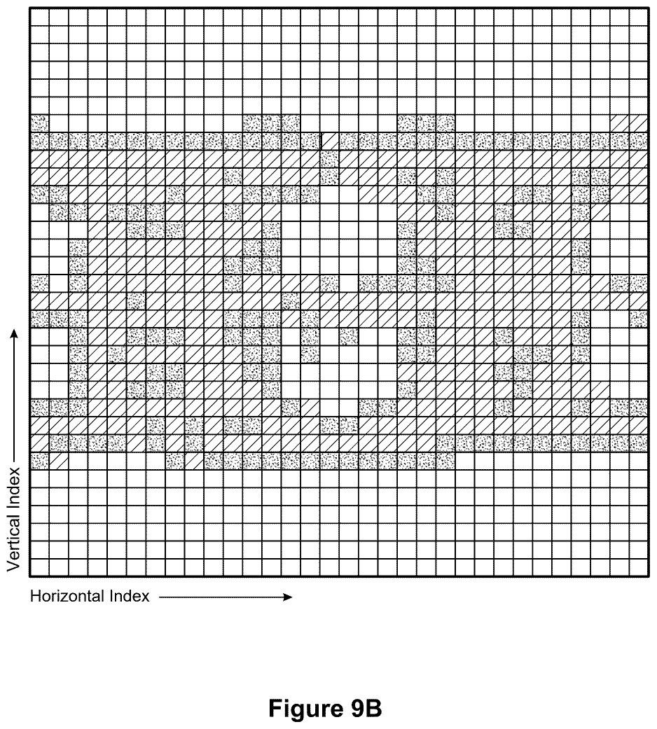

In accordance with some implementations, there are one or more programmable controls for the performing the eye-diagram measurement and/or monitoring. For example, a dwell time of each point of the CDF/PDF measurement can be programmed, in accordance with some implementations. In some implementations, if the data being analyzed comprises a repeating pattern, then the dwell time should be set to an integer multiple of the pattern length such that a resultant CDF measured at each point consists of an equal number of data symbols. An illustration of the dwell time is shown in FIG. 9A.

FIGS. 9A and 9B show example aspects of an eye-sweeping process using the claimed techniques. In some embodiments, the methods described herein include sweeping, using an analog slicer (e.g., a data slicer and/or an error slicer), across a plurality of indices of a digital wireline signal. In some implementations, a first index of the plurality of indices represents the probability of the signal having a particular voltage at a particular phase of one or more intervals represented by a second index of the plurality of indices. In some implementations, after the error slicer has performed the sweeping along each respective index of the plurality of indices, the system accumulates output data from the error slicer.

FIG. 9A shows example visualizations of a process for sweeping across both horizontal and vertical indices for construction of an eye diagram, in accordance with some implementations. In some implementations, as indicated by the upper graph in FIG. 9A, the sweeping of the vertical index is nested within the sweeping of the horizontal index. At each vertical index, the accumulator is reset and then starts counting until a programmable timer has elapsed.

This proposed method is also suitable for PAM-N modulation without any modification in circuitry. FIG. 9B shows an example PAM-3 eye (e.g., utilizing USB4 version 2.0 standard (USB4V2)) measured using the proposed method.

FIG. 9B shows an example of an eye diagram of a PAM-3 signal measured using the method described with respect to one or more of the architectures described herein. The different fill patterns in the graph indicate the different Since the method measures PDF of the signal regardless of modulation (e.g., the number of signal levels), it is suitable for PAM-N signals as well and no changes in circuitry is needed. A single error slicer can be used to measure the eye diagram regardless of modulation.

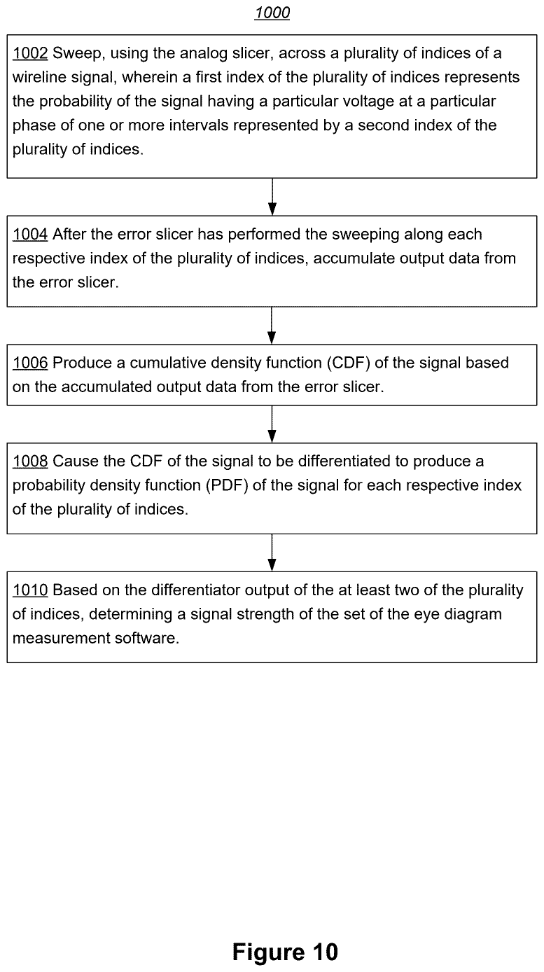

FIG. 10 is a flow diagram of an example method 1000 for in-situ eye diagram measurement, in accordance with some implementations. For convenience, the method 1000 is described as being implemented by the electronic device.

(A1) The electronic device sweeps (1002), using the analog slicer, across a plurality of indices of a wireline signal (e.g., a signal transmitted over a filament or other physical medium), wherein a first index (e.g., a vertical index) of the plurality of indices represents the probability of the signal having a particular voltage at a particular phase of one or more intervals (e.g., unit intervals) represented by a second index (e.g., a horizontal index) of the plurality of indices.

The electronic device, after the error slicer has performed the sweeping along each respective index of the plurality of indices, accumulates (1004) output data from the error slicer. For example, the error slicer 424 and the data slicer 424 (FIG. 4C) provide output data to the eye-monitor logic 418, including the accumulator 430 (FIG. 4C).

The electronic device produces (1006) a cumulative density function (CDF) of the signal based on the accumulated output data from the error slicer (error slicer threshold control). In some implementations, the differentiated signal is configured to represent a two-dimensional representation of the eye diagram without using additional analog data from the analog slicer.

The electronic device causes (1008) the CDF of the signal to be differentiated to produce a probability density function (PDF) of the signal for each respective index of the plurality of indices. For example, FIG. 7B shows a CDF representation 704 is differentiated to produce the PDF representation 706.

The electronic device, based on the differentiator output of the at least two of the plurality of indices, determines (1010) a signal strength of the digital wireline receiver.

(A2) In some implementations of A1, in accordance with determining that the signal strength of the digital wireline receiver is below the threshold quality level, the electronic device presents an indication, via a presentation component in electronic communication with the digital wireline receiver.

(A3) In some implementations of A1 or A2, the signal strength is based on an area of the differentiator output having a voltage above a threshold distinction level. That is, in some implementations, when the signal quality is relatively higher, there is an open portion (e.g., an “eye”) within the constructed eye diagram. In contrast, when the signal quality is poor, the open portion is relatively smaller and the symbol levels representing the respective voltages are not clearly separated.

(A4) In some implementations of any one of A1 to A3, the electronic device, in accordance with determining that the signal strength of the digital wireline receiver is below the threshold quality level, performing a mitigation technique selected from a group consisting of: (i) adjusting a programmable dwell time between movements of the sweeping, and/or (ii) re-positioning one or more pieces of equipment comprising the digital wireline receiver. In some implementations, if the data is a repeating pattern, the dwell time should be set to an integer multiple of the pattern length so that the CDF measured at each point consists of an equal number of data symbols.

(A5) In some implementations of any one of A1 to A4, the analog slicer sweeps across the first index with a first programmable dwell time, and the analog slicer sweeps across the second index with a second programmable dwell time.

(A6) In some implementations of any one of A1 to A5, the first programmable dwell time and the second programmable dwell time are distinct.

(A7) In some implementations of any one of A1 to A6, the digital wireline receiver is suitable for pulse-amplitude modulation (PAM) (e.g., PAM-N modulation, PAM-3). For example, FIG. 9B shows the eye-diagram-monitoring software being used to measure a PAM-3 eye diagram.

(B1) In some implementations, an electronic system is provided for in-situ non-destructive eye diagram measurement, the electronic system includes (i) an analog slicer, (ii) a digital wireline receiver, (iii) one or more processors, and (iv) memory, comprising eye-diagram-monitoring software that includes instructions for performing any of the operations of any one of A1 to A7.

It should be understood that the particular order in which the operations in FIG. 10 has been described are merely exemplary and are not intended to indicate that the described order is the only order in which the operations could be performed. One of ordinary skill in the art would recognize several ways to controlling clock data recovery for a data communication channel. Additionally, it should be noted that details of other processes and structures described above with respect to FIGS. 1-9B are also applicable in an analogous manner to method 1000 described above with respect to FIG. 10. For brevity, these details are not repeated here.

In some implementations, method 1000 is, optionally, governed by instructions that are stored in a non-transitory computer readable storage medium and that are executed by one or more processors of the electronic device. Each of the operations shown in FIG. 10 may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1000 may be combined and/or the order of some operations may be changed.

It will also be understood that, although the terms first, second, etc. are, in some instances, used herein to describe various elements, these elements should not be limited by these terms. These terms are only used to distinguish one element from another. For example, a first electronic device can be termed a second electronic device, and, similarly, a second electronic device can be termed a first electronic device, without departing from the scope of the various described implementations. The first electronic device and the second electronic device are both electronic device, but they are not the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software, or any combination thereof.

The above description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method of monitoring data interface signal quality in a digital wireline receiver, comprising:
obtaining output data from one or more analog slicers, wherein the output data represents a result of sweeping across a plurality of indices of a digital wireline signal;
producing a cumulative density function (CDF) of the digital wireline signal based on an accumulated output data from the one or more analog slicers;
causing the CDF of the digital wireline signal to be differentiated to produce a probability density function (PDF) of the digital wireline signal for each respective index of the plurality of indices; and
based on the PDF of the digital wireline signal, determining a signal strength of the digital wireline receiver.

2. The method of claim 1, further comprising:
in accordance with determining that the signal strength of the digital wireline receiver is below a threshold quality level, presenting an indication, via a presentation component in electronic communication with the digital wireline receiver.

3. The method of claim 1, wherein the determining the signal strength is based on an area of the PDF having a voltage above a threshold distinction level.

4. The method of claim 1, further comprising:
in accordance with determining that the signal strength of the digital wireline receiver is below a threshold quality level, performing a mitigation technique selected from a group consisting of:
adjusting a programmable dwell time between movements of the sweeping by at least one of the one or more analog slicers, and
re-positioning one or more pieces of equipment comprising the digital wireline receiver.

5. The method of claim 1, wherein:
a respective slicer of the one or more analog slicers sweeps across a first index with a first programmable dwell time, and
another respective slicer of the one or more analog slicers sweeps across a second index with a second programmable dwell time.

6. The method of claim 5, wherein the first programmable dwell time and the second programmable dwell time are distinct.

7. The method of claim 1, wherein the digital wireline receiver is suitable for pulse-amplitude modulation (PAM).

8. An electronic system for in-situ non-destructive eye diagram measurement, comprising:
one or more analog slicers;
a digital wireline receiver;
one or more processors, and
memory, comprising a digital wireline receiver that includes instructions for performing operations for:
obtaining output data from the one or more analog slicers, wherein the output data represents a result of sweeping across a plurality of indices of a digital wireline signal;
producing a cumulative density function (CDF) of the digital wireline signal based on an accumulated output data from the one or more analog slicers;
causing the CDF of the digital wireline signal to be differentiated to produce a probability density function (PDF) of the digital wireline signal for each respective index of the plurality of indices; and
based on the PDF of the digital wireline signal, determining a signal strength of the digital wireline receiver.

9. The electronic system of claim 8, wherein the memory further includes instructions for:
in accordance with determining that the signal strength of the digital wireline receiver is below a threshold quality level, presenting an indication, via a presentation component in electronic communication with the digital wireline receiver.

10. The electronic system of claim 8, wherein the determining the signal strength is based on an area of the PDF having a voltage above a threshold distinction level.

11. The electronic system of claim 8, wherein the memory further includes instructions for:
in accordance with determining that the signal strength of the digital wireline receiver is below a threshold quality level, performing a mitigation technique selected from a group consisting of:
adjusting a programmable dwell time between movements of the sweeping by at least one of the one or more analog slicers, and/or
re-positioning one or more pieces of equipment comprising the digital wireline receiver.

12. The electronic system of claim 8, wherein:
a respective analog slicer of the one or more analog slicers sweeps across a first index with a first programmable dwell time, and
another respective analog slicer of the one or more analog slicers sweeps across a second index with a second programmable dwell time.

13. The electronic system of claim 12, wherein the first programmable dwell time and the second programmable dwell time are distinct.

14. The electronic system of claim 8, wherein the digital wireline receiver is suitable for pulse-amplitude modulation (PAM).

15. A non-transitory, computer-readable storage medium, comprising instructions that, when executed by one or more processors, cause operations comprising:
obtaining output data from one or more analog slicers, wherein the output data represents a result of sweeping across a plurality of indices of a digital wireline signal;
producing a cumulative density function (CDF) of the digital wireline signal based on an accumulated output data from the one or more analog slicers;
causing the CDF of the digital wireline signal to be differentiated to produce a probability density function (PDF) of the digital wireline signal for each respective index of the plurality of indices; and
based on the PDF of the digital wireline signal, determining a signal strength of a digital wireline receiver.

16. The non-transitory, computer-readable storage medium of claim 15, further comprising instructions for:
in accordance with determining that the signal strength of the digital wireline receiver is below a threshold quality level, presenting an indication, via a presentation component in electronic communication with the digital wireline receiver.

17. The non-transitory, computer-readable storage medium of claim 15, wherein the determining the signal strength is based on an area of the PDF having a voltage above a threshold distinction level.

18. The non-transitory, computer-readable storage medium of claim 15, further comprising instructions for:
in accordance with determining that the signal strength of the digital wireline receiver is below a threshold quality level, performing a mitigation technique selected from a group consisting of:
adjusting a programmable dwell time between movements of the sweeping by at least one of the one or more analog slicers, and/or
re-positioning one or more pieces of equipment comprising the digital wireline receiver.

19. The non-transitory, computer-readable storage medium of claim 15, wherein:
a respective analog slicer of the one or more analog slicers sweeps across a first index with a first programmable dwell time, and
another respective analog slicer of the one or more analog slicers sweeps across a second index with a second programmable dwell time.

20. The non-transitory, computer-readable storage medium of claim 19, wherein the first programmable dwell time and the second programmable dwell time are distinct.
